(19) United States
(12) Patent Application Publication
(10) Pub. No.: US 2011/0109990 A1
(43) Pub. Date: May 12, 2011

(54) FIXING APPARATUS AND DISK DRIVE ASSEMBLY HAVING THE SAME

(75) Inventors: TSAI-YI FANG, Tu-Cheng (TW); CHIH-WEI KE, Tu-Cheng (TW); CHAO-TANG WANG, Tu-Cheng (TW)

(73) Assignee: HON HAI PRECISION INDUSTRY CO., LTD., Tu-Cheng (TW)

(21) Appl. No.: 12/638,993

(22) Filed: Dec. 16, 2009

(30) Foreign Application Priority Data
Nov. 12, 2009 (TW) 98138476

(51) Int. Cl. G11B 17/08

(52) U.S. Cl. 360/98.08; G9B/17.041

(57) ABSTRACT

A fixing apparatus for securing an HDD, includes a carrier containing the HDD and a plurality of fixtures to secure the HDD in the carrier. The carrier includes a bottom frame and two opposite sidewalls connected to two opposite edges of the bottom frame. Each fixture includes a post and a cushion. The cushions are fixed in the sidewalls and abut against two opposite sides of the HDD. The posts are extended through the cushions and inserted into the two opposite sides of the HDD to hold the HDD spaced apart from the bottom frame and the sidewalls of the carrier.

### BACKGROUND

1. Technical Field

The present disclosure relates to fixing apparatuses, and particularly to a fixing apparatus for hard disk drives (HDDs).

2. Description of Related Art

In order to reduce noise, rigid specifications for sound quality have been enacted in industry. In those specifications, loudness, tonality, and modulation strength are all important measurable parameters.

In an electronic device such as a computer, a motor is commonly employed in an HDD mounted in a fixing apparatus in a casing of the electronic device. When the HDD is in operation, the motor rotating at a high speed will create a high frequency vibration in the HHD. The high frequency vibration of the HDD will be further transferred to the fixing apparatus and cause contact among the HDDs, as a result, the fixing apparatus and the casing produce loud and continuous noises.

What is desired, therefore, is a HDD fixing apparatus capable of reducing vibration and noise from the HDD.

### BRIEF DESCRIPTION OF THE DRAWINGS

FIG. 1 is an isometric view of a fixing apparatus in accordance with an embodiment of the disclosure assembled with an HDD.

FIG. 2 is an exploded, isometric view of the fixing apparatus of FIG. 1.

FIG. 3 is an enlarged view of a part of the fixing apparatus in a circular line III of FIG. 2.

FIG. 4 is a rear side view of the fixing apparatus of FIG. 1 assembled with the HDD.

### DETAILED DESCRIPTION

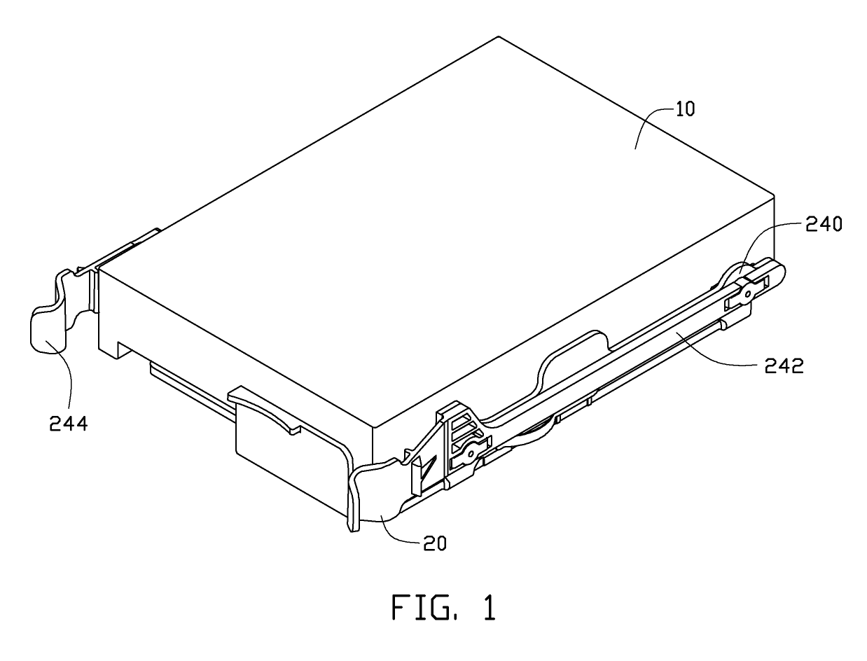

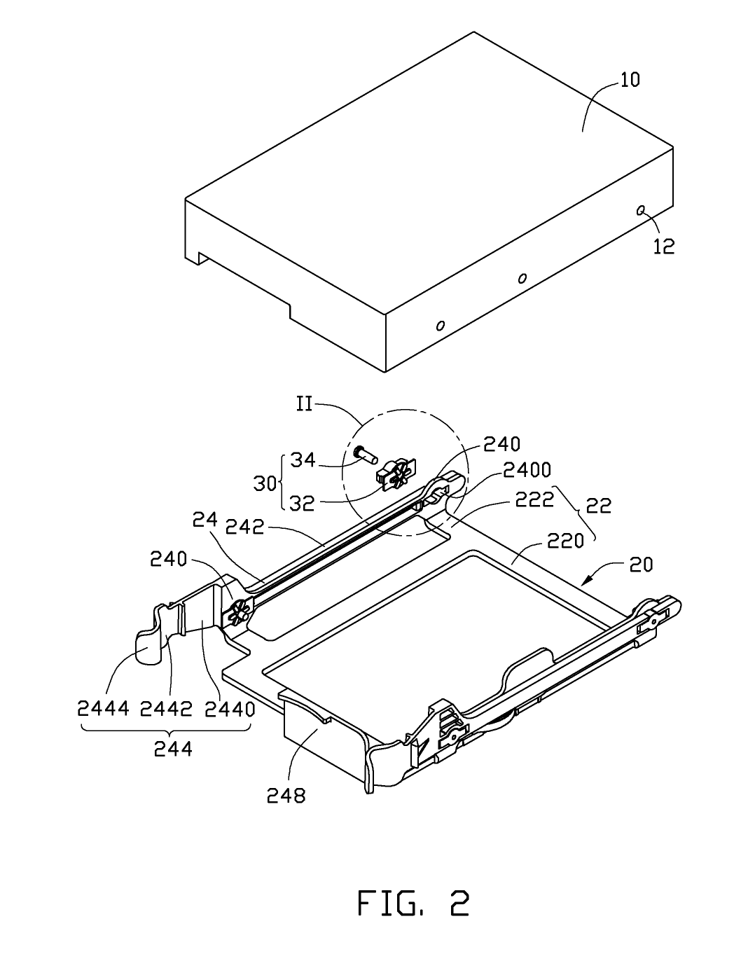

Referring to FIGS. 1 and 2, a hard disk device in accordance with an embodiment of the present disclosure includes a hard disk drive (HDD) 10 and a fixing apparatus fixing the HDD 10 in a rack of an electronic device (not shown). The fixing apparatus includes a carrier 20 containing the HDD 10 and a plurality of fixtures 30 securing the HDD 10 to the carrier 20. A plurality of fixing holes 12 is defined in two opposite sides of the HDD 10 for engagingly receiving the fixtures 30 therein.

The carrier 20 may be made of a pliable material such as certain plastics, and integral to the structure of the carrier 20 are a bottom frame 22 and two opposite sidewalls 24 connected to two opposite edges of the bottom frame 22. A baffling plate 248 extends upwardly from part of a front end of the bottom frame 22. The bottom frame 22, the baffling plate 248 and the two sidewalls 24 cooperatively define a space for receiving the HDD 10. The bottom frame 22 includes a base 220 connected to the two sidewalls 24 by a number of connecting portions 222. In the present embodiment, two connecting portions 222 extend horizontally and outwardly from two opposite sides of a rear end of the base 220, and another two connecting portions 222 extend horizontally and outwardly from two opposite sides of a front end portion of the base 220. It is understood that structures and number of the connecting portions 222 are not limited, so long as they can connect the two sidewalls 24 to the two opposite edges of the bottom frame 22.

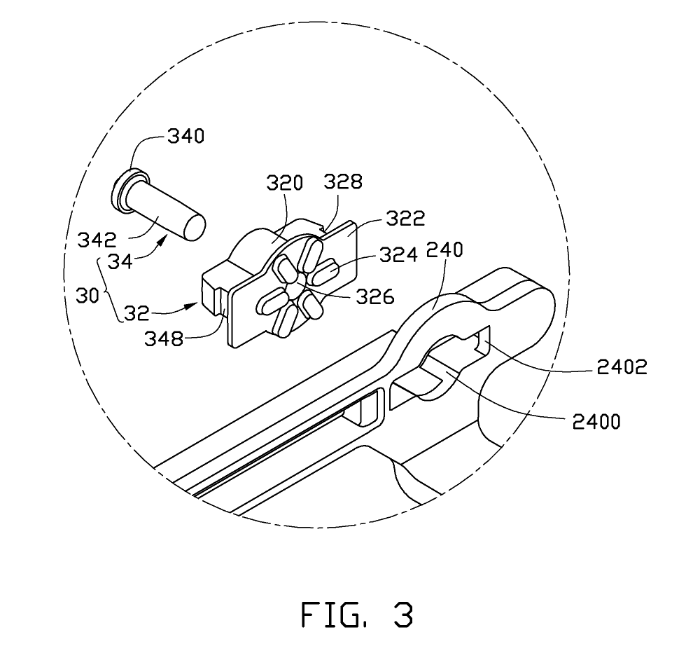

Each of the two sidewalls 24 includes two separated mounting parts 240, an elongated guardrail 242 between the two mounting parts 240 and a clipping part 244 extending outwardly and forwardly from one of the mounting parts 240. Each mounting part 240 extends upwardly from an outer free end of the corresponding connecting portion 222 of the bottom frame 22. A positioning hole 2400 is defined in each mounting part 240 for receiving one of the fixtures 30 therein. As particularly shown in FIG. 3, the positioning hole 2400 has an elongated configuration and comprises a circular part in middle thereof and two rectangular parts extending outwardly and contrarily from two opposite sides of the circular part. Two restricting protrusions 2402 extend inwardly into the positioning hole 2400 from two vertical inner sides of the positioning hole 2400 opposite to each other and are located adjacent to the inner side of the mounting part 240.

The elongated guardrail 242 of each sidewall 24 is located between and connected to the two mounting parts 240 of the sidewall 24. The elongated guardrail 242 is separated from and parallel to the bottom frame 22.

The clipping parts 244 extending forwardly from the two corresponding mounting parts 240 are configured for securing the fixing apparatus assembled with the HDD 10 to the rack of the electronic device. Each clipping part 244 includes a plate-like extending section 2440 extending forward from a front side of the corresponding mounting part 240, an engaging section 2442 extending forward from a free end of the extending section 2440, and a handle 2444 connected to a free end of the engaging section 2442. The engaging section 2442 is an arc-shaped sheet, which extends outwardly and protrudes from the extending section 2440. The handle 2444 is a sheet and extends outwardly from the engaging section 2442. The engaging section 2442 and the handle 2444 cooperatively form an S-shaped configuration with certain elasticity. The engaging sections 2442 of the two clipping parts 244 of the two sidewalls 24 are configured to be received in two opposite grooves of the rack of the electronic device, thereby securing the HDD 10 in the electronic device.

The number of the fixtures 30 used to secure the HDD 10 in the carrier 20 corresponds to that of the mounting parts 24 of the carrier 20 and is four in this embodiment. Referring to FIG. 3, each fixture 30 comprises a cushion 32 and a post 34. Each cushion 32 is made of soft plastic and comprises a main body 320, a gasket part 322 extending outwardly from a circumferential edge of a side of the main body 320, and a plurality of ribs 324 protruding outwardly from the side of the main body surrounded by the gasket part 322. The main body 320 has a configuration complementing the positioning hole 2400 of the mounting part 240 of the carrier 20 and correspondingly comprises a circular part and two rectangular parts extending outwardly and contrarily from two opposite sides of the circular part. A through hole 326 is defined through a central axis of the main body 320 for receiving the post 34. Two cutouts 328 are defined in two opposite sides of the main body 320 and adjacent to the gasket 322. The ribs 324 are arranged around the through hole 326 on the side of the main body 320 and extend outwardly and radially from the through hole 326. The ribs 324 are centro-symmetrically arranged on the side of the main body 320 relative to the through hole 326. Each post 34 has a circular head 340 and an elongated shaft 342 extending from the head 340. A diameter of the shaft 342 is smaller than that of the head 340, and larger than a caliber of the through hole 326 of the cushion 32, so that the shaft 342 can be tightly received in the through hole 326.

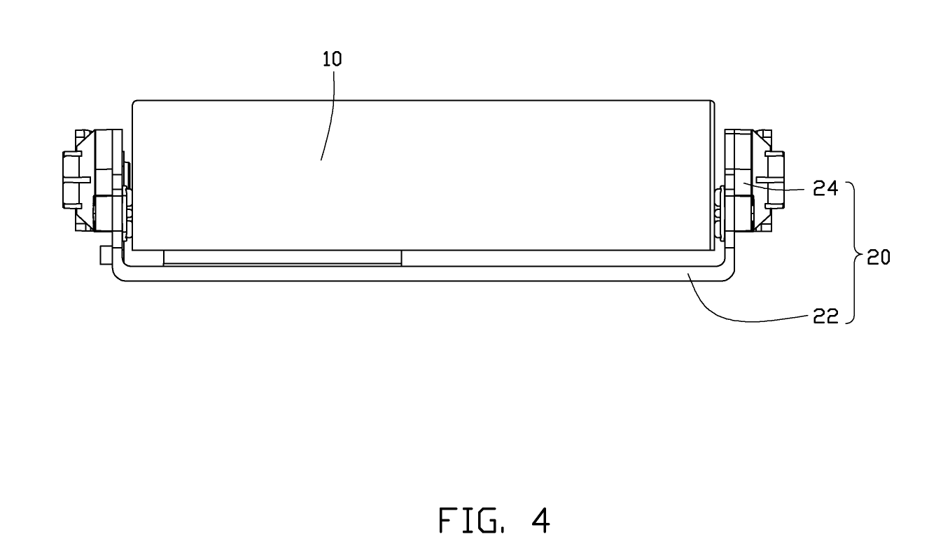

Also referring to FIG. 4, in assembly of the disk device assembly, the HDD 10 is contained in the carrier 20 and spaced apart from the bottom frame 22. The main bodies 320 of the cushions 32 are inserted into the positioning holes 2400 of the sidewalls 24, respectively. The gaskets 322 of the cushion 32 abut against the inner sides of the mounting parts 240 of the sidewalls 24 to make the ribs 324 located between the inner sides of the sidewalls 24 and the two opposite sides of the HDD 10. The restricting protrusions 2402 in the positioning holes 2400 are engagingly received in the cutouts 348 of the corresponding main bodies 320, respectively, to hold the main bodies 320 of the cushions 32 in the positioning holes 2400 of the sidewalls 24 and keep the ribs 324 abutting against the two opposite sides of the HDD 10. The shafts 342 of the posts 34 are extended through the through holes 326 of the cushions 32 and inserted into the fixing holes 12 of the HDD 10, respectively, with the heads 340 of the posts 34 abutting against outer sides of the cushions 32 at the outer sides of the sidewall 24.

As described above, the HDD 10 secured in the carrier 20 by the fixtures 30 only contacts the posts 34 and the cushions 32 of the fixtures 30 and does not contact any part of the carrier 20, whereby the carrier 20 and the HDD 10 are separated from each other by the cushions 32 and avoid striking each other. Thus, noise from collisions between the carrier 20 and the HDD 10 is greatly reduced. Furthermore, since the cushions 32 are made of soft plastic which has good shock absorption qualities, vibrations produced by the operating HDD 10 are mostly absorbed or damped by the cushions 32, and are too weak to cause collisions between the carrier 10 and other parts.

It is to be understood, however, that even though numerous characteristics and advantages of the present embodiments have been set forth in the foregoing description, together with details of the configurations and functions of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A fixing apparatus for securing an HDD, comprising:
a carrier containing the HDD therein, the carrier comprising a bottom frame and two opposite sidewalls connected to two opposite edges of the bottom frame; and
a plurality of fixtures mounted on the carrier to hold the HDD spaced apart from the bottom frame and the sidewalls of the carrier, each of the fixture comprising an elastic cushion fixed in the sidewalls and abutting against one of two opposite sides of the HDD, and a post extended through the cushion and inserted into the side of the HDD.

2. The fixing apparatus of claim 1, wherein a plurality of positioning holes is defined in the sidewalls and receives the cushions therein, respectively.

3. The fixing apparatus of claim 2, wherein each cushion comprises a main body received in a positioning hole and a gasket part extending outwardly from a circumferential edge of an inner side of the main body, the gasket abutting against an inner side of one of the sidewalls and surrounding the positioning hole.

4. The fixing apparatus of claim 3, wherein the cushion has a plurality of ribs protruding from the inner side of the main body and abutting against the HDD, the ribs being located between the HDD and the sidewall.

5. The fixing apparatus of claim 4, wherein the main body defines a through hole in a center thereof for the post extending through.

6. The fixing apparatus of claim 5, wherein the ribs extend outwardly and radially from the through hole.

7. The fixing apparatus of claim 4, wherein two cutouts are defined in two opposite sides of the main body and adjacent to the gasket, two restricting protrusions extend inwardly into the positioning hole from two vertical inner sides of the positioning hole opposite to each other and are engagingly received in the two cutouts to hold the main body in the positioning hole.

8. The fixing apparatus of claim 4, wherein the main body has a configuration in complement with the positioning hole and correspondingly comprises a circular part and two rectangular parts extending outwardly and contrarily from two opposite sides of the circular part.

9. The fixing apparatus of claim 4, wherein each of the two sidewalls comprises two separated mounting parts in which the positioning hole are defined, an elongated guardrail connecting to the two mounting parts and a clipping part extending outwardly and forwardly from one of the mounting parts.

10. The fixing apparatus of claim 4, wherein the elongated guardrail is located between the two mounting parts and parallel to and separated from the bottom frame.

11. A disk drive assembly, comprising:
an HDD;
a carrier containing the HDD therein, the carrier comprising a bottom frame and two opposite sidewalls connected to two opposite edges of the bottom frame;
a plurality of plastic cushions fixed in the sidewalls and having a plurality of ribs projecting inwardly to abut against two opposite sides of the HDD; and
a plurality of posts extended through the cushions and inserted into the two opposite sides of the HDD to hold the HDD spaced apart from the bottom frame and the sidewalls of the carrier.

12. The disk drive assembly of claim 11, wherein a plurality of positioning hole is defined in the sidewalls and receive the cushions therein, respectively.

13. The disk drive assembly of claim 12, wherein each cushion comprises a main body received in a positioning hole and a gasket part extending outwardly from a circumferential edge of an inner side of the main body, the gasket abutting against an inner side of one of the sidewalls and surrounding the positioning hole.

14. The disk drive assembly of claim 13, wherein the plurality of ribs protrudes inwardly from the inner side of the main body and located between the HDD and the sidewall.

15. The disk drive assembly of claim 11, wherein the main body in a center thereof defines a through hole through which the post is extended.

16. The disk drive assembly of claim 15, wherein the ribs extend outwardly and radially from the through hole.

17. The disk drive assembly of claim 13, wherein two cutouts are defined in two opposite sides of the main body and adjacent to the gasket, two restricting protrusions extend inwardly into the positioning hole from two vertical inner sides of the positioning hole opposite to each other and are engagingly received in the two cutouts to hold the main body in the positioning hole.

18. The disk drive assembly of claim 12, wherein the main body has a configuration in complement with the positioning hole and correspondingly comprises a circular part and two rectangular parts extending outwardly and contrarily from two opposite sides of the circular part.
